(19) United States
(12) Patent Application Publication
(10) Pub. No.: US 2014/0068353 A1
(43) Pub. Date: Mar. 6, 2014

(54) Estimation of Hidden Variance Distribution Parameters

(71) Applicants: Craig H. Bishop, Monterey, CA (US); Elizabeth Ann Satterfield, Monterey, CA (US)

(72) Inventors: Craig H. Bishop, Monterey, CA (US); Elizabeth Ann Satterfield, Monterey, CA (US)

(73) Assignee: The Government of the United States of America, as represented by the Secretary of the Navy, Arlington, VA (US)

(21) Appl. No.: 14/015,061

(22) Filed: Aug. 30, 2013

Related U.S. Application Data
(60) Provisional application No. 61/695,341, filed on Aug. 31, 2012.

(51) Int. Cl. G06F 11/08

(52) U.S. Cl. CPC G06F 11/08
USPC 714/49

(57) ABSTRACT

Methods for finding (i) the parameter var(σ²), representing the variance of a prior historical distribution ρ_{C}(σ²) of hidden error variances σ²; (ii) the parameter “a” defining the rate of change of the mean ensemble variance response to changes in true error variance; (iii) the parameter σ²ₘᵢₙ representing a prior historical minimum of true error variance; (iv) the parameter k⁻¹, representing the relative variance of the stochastic component of variance prediction error; and (v) the parameter M, representing the effective ensemble size.

### CROSS-REFERENCE

This application is a Nonprovisional of, and claims the benefit of priority under 35 U.S.C. §119 based on, U.S. Provisional Patent Application No. 61/695,341 filed on Aug. 31, 2012, the entirety of which is hereby incorporated by reference into the present application.

### TECHNICAL FIELD

The present invention relates to all technical fields in which one attempts to predict the variance of a quantity and direct measurements of this variance are unavailable, thus making the instantaneous variance “hidden.” Such technical areas include ensemble-based state estimation in which one uses prediction of flow dependent error variances to optimize state estimation. Ensemble based state estimation is used across a very broad range of fields, including atmospheric and oceanic state estimation, oil and gas reservoir state estimation and stock price volatility prediction.

### BACKGROUND

Over the last few decades, there has been an enormous amount of research and development of state estimation systems that utilize predictions of variances. Hence, variance prediction is relevant to a wide variety of fields ranging from weather forecasting to predicting values in a financial market. Such systems include ensemble forecasting systems, ensemble Kalman filters, particle filters, and Hybrid 4D-Var data assimilation schemes. See, e.g., Toth, Z. and E. Kalnay, 1997: Ensemble forecasting at NCEP and the breeding method, Mon. Wea. Rev., 125, 3297-3319; Molteni, F., R. Buizza, T. N. Palmer, and T. Petroliagis, 1996: The ECMWF ensemble prediction system: Methodology and validation. Quart. J. Roy. Meteor. Soc., 122, 73-119; Houtekamer, P. L., L. Lefaivre, J. Derome, H. Ritchie, and H. L. Mitchell, 1996: A system simulation approach to ensemble prediction. Mon. Wea. Rev., 124, 1225-1242; Bishop, C. H., B. J., Etherton and S. J. Majumdar, 2001: Adaptive Sampling with the Ensemble Transform Kalman Filter. Part I: Theoretical Aspects. Mon. Wea. Rev. 129, 420-436; Houtekamer P. L., and H. L. Mitchell, 2001: A sequential ensemble Kalman filter for atmospheric data assimilation. Mon. Wea. Rev., 129, 123-137; Anderson J. L., 2001: An ensemble adjustment Kalman filter for data assimilation. Mon. Wea. Rev., 129, 2884-2903; Whitaker, Jeffrey S., Thomas M. Hamill, 2002: Ensemble Data Assimilation without Perturbed Observations. Mon. Wea. Rev., 130, 1913-1924; Hunt, B. R., Szunyogh, I. Zimin, A. V., Kostelich, E. J., Corazza, M., Kalnay, E., Patil, D. J. and J. A. Yorke, 2004: A local ensemble Kalman filter for atmospheric data assimilation. TELLUS A, 56, 415-428; Hunt, B. R., Kostelich E. J.; Szunyogh I., 2007: Efficient data assimilation for spatiotemporal chaos: A local ensemble transform Kalman filter. Physica D-NONLINEAR PHENOMENA, 230, 112-126; and van Leeuwen, P. J., 2009: Particle Filtering in Geophysical Systems. Mon. Wea. Rev., 137, 4089-4114.

In these systems, the true variance changes from one instant to the next and one location to the next and an attempt is made to predict the spatio-temporal evolution of the true variance. Typically, the creator of the system expects the predictions of true variance to be inaccurate because of poorly accounted for sources of variance. Since the utility of state estimation and ensemble forecasting systems is closely linked to the accuracy of their variance predictions, measurements of the accuracy of variance prediction are of great interest. In spite of this fact, very little progress has been made over the past few decades in measuring variance prediction accuracy in chaotic and aperiodic systems.

It is non-trivial to measure variance prediction accuracy when the conditions associated with a variance prediction do not repeat themselves enough to obtain a condition-dependent sample large enough to compute the mean and variance of the sample. In aperiodic systems such as the atmosphere, the ocean, financial markets, or oil reserves, such a lack of condition-relevant samples is very common and, in these circumstances, the condition-dependent variance is hidden. If the variance is hidden, it is non-trivial to define prior distributions of hidden variance and/or distributions of hidden variances conditioned on a prediction of hidden variance because one cannot simply observe the frequency at which the hidden variances occur at different values. The invention described in this patent solves this non-trivial problem with new tools derived from advanced statistical analysis. For the first time, the invention enables parameters such as the mean, variance, and minimum value of distributions of hidden variances to be measured.

One prior approach to inferring aspects of the accuracy of a hidden variance prediction system is described in Majumdar, S. J., C. H. Bishop, I. Szunyogh and Z. Toth, 2001: Can an Ensemble Transform Kalman Filter predict the reduction in forecast error variance produced by targeted observations? Quart. J. Roy. Met. Soc. 127, 2803-2820 (Majumdar 2001).

In the Majumdar approach, one obtains a large collection of (variance-prediction, realization) pairs by exercising the variance prediction system. One then orders the data pairs from smallest variance prediction to largest variance prediction and then splits this ordered list into equally populated sub-bins. If each variance prediction was precisely equal to the true hidden variance then the variance of the realizations within each bin would be equal to the mean variance prediction in each bin provided that only a small range of predicted variances were represented in each bin. The extent to which the variance of the realizations within the bin are not equal to the bin averaged predicted variance then provides a qualitative indication of variance prediction accuracy.

However, this prior approach is an uninformative measure of variance-prediction inaccuracy. Often one will find that the bin averaged variance prediction underestimates (overestimates) the bin variance when the variance prediction is small (large) but is approximately equal to the bin variance at some intermediate variance prediction value. This type of problem could be caused by a systematic variance prediction error that is positive (negative) for small (large) true values of variance. But it could also be caused by a purely random deviation of the predicted variance from the true variance. To understand this second possibility, note that in any finite data set, the distribution of true variances will have a finite range of values. Consequently, if the error in the variance prediction was purely random, the extremely small (large) variance predictions from the data set must correspond to true variances that were, on average, larger (smaller) than the corresponding extreme variance predictions. For variance predictions that correspond to the mean true variance in the data set, it is possible for the bin variance to be precisely equal to the bin average of the predicted variance because positive random prediction errors within this bin may be balanced by negative prediction errors. Consequently, the major problem with the Majumdar 2001 method of assessing variance prediction accuracy is that it is incapable of distinguishing between systematic and random variance prediction errors. The invention described herein solves this problem by measuring both the stochastic and systematic aspects of variance prediction inaccuracy.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

The present invention provides a computer-implemented instrument for measuring properties of distributions associated with hidden variances. As input, it requires a large set of condition dependent error variance predictions sᵢ², i=1, 2, . . . , n associated with a corresponding set of forecasts xᵢ^{f}, i=1, 2, . . . , n and a corresponding set of observations yᵢ, i=1, 2, . . . , n that can be used to measure the error in the forecasts.

A computer-implemented instrument in accordance with the present invention measures the mean [symbol] σ² [symbol] , the minimum σₘᵢₙ², and the variance var(σ²), respectively, of a prior historical distribution ρ_{C}(σ²) of hidden error variances σ² associated with an input data set. The prior measuring tool of Majumdar 2001 provides no information about these quantities. Indeed, our new invention is the first to be able to measure these quantities.

The present invention also provides a method for measuring the mean, minimum sₘᵢₙ², and relative variance k⁻¹ of the distribution ρ_{L}(s²|σ²) of variance predictions s² given a fixed true error variance σ². The present invention gives the mean variance prediction given a fixed σ² in the form a(σ²−σₘᵢₙ²)+sₘᵢₙ², where the parameters “a” and sₘᵢₙ² define the systematic component of error variance prediction inaccuracy. In addition, it gives the random or stochastic component of error variance prediction inaccuracy in terms of the relative variance k⁻¹. Thus, unlike the prior art method of Majumdar 2001, the method of the present invention explicitly defines and distinguishes between the systematic and random aspects of variance prediction inaccuracy.

The method of the present invention also estimates the mean, minimum, and relative variance of the posterior distribution ρ_{P}(σ²|s²) of true error variances given an imperfect error variance prediction s².

In accordance with the present invention, the parameters [ [symbol] σ² [symbol] , sₘᵢₙ², var(σ²), a, σₘᵢₙ², k⁻¹, and M] of a variance distribution can be found from a long time series of (ensemble variance, forecast, observation) triplets (sᵢ², xᵢ^{f}, yᵢ), i=1, 2, . . . , n from a single ensemble forecasting system. From this set of triplets, one can readily compute a corresponding time series of (innovation, ensemble-variance) data pairs (vᵢ, sᵢ²), i=1, 2, . . . , n data pairs where each innovation vᵢ=yᵢ−xᵢ^{f} is simply the difference between the verifying observation yᵢ and its corresponding forecast xᵢ^{f}.

Two of these parameters, [symbol] σ² [symbol] , the mean of a prior historical distribution of instantaneous variances, and sₘᵢₙ², a minimum of variance predictions can easily be found using (innovation, ensemble-variance) data pairs (vᵢ, sᵢ²), i=1, 2, . . . , n data pairs and the error variances Rᵢ of the ith observation, where [symbol] σ² [symbol] = [symbol] v²−R [symbol] and sₘᵢₙ²=min(sᵢ²) over all i if sample is large.

The parameter var(σ²), i.e., the variance of a prior historical distribution of error variances can be found in accordance with the present invention, where

$$\begin{matrix}var ( {σ}^{2} ) = \frac{〈 {v}^{4} 〉}{3} - {( 〈 {σ}^{2} 〉 + 〈 R 〉 )}^{2} - var ( R ) \\ = {( 〈 {σ}^{2} 〉 + 〈 R 〉 )}^{2} [ \frac{kurtosis ( v ) - 3}{3} ] - var ( R ) .\end{matrix}$$

The parameter “a” that defines the mean response of variance predictions to changes in the true error variance can be found in accordance with the present invention, where

$$a = \frac{covar ( {v}^{2} , {s}^{2} )}{var ( {σ}^{2} )} .$$

The minimum possible true variance σₘᵢₙ² of a prior historical distribution of hidden variances can also be measured in accordance with the present invention, such that

$${σ}_{min}^{2} = 〈 {σ}^{2} 〉 - \frac{〈 {s}^{2} 〉 - {s}_{min}^{2}}{a} .$$

Finally, an effective ensemble size M and k⁻¹, the relative variance of the variance prediction error, can be found in accordance with the present invention, where

$${k}^{- 1} = \frac{var ( {s}^{2} ) - {a}^{2} var ( {σ}^{2} )}{{a}^{2} [ {( 〈 {σ}^{2} 〉 - {σ}_{min}^{2} )}^{2} + var ( {σ}^{2} ) ]}$$

$$and$$

$$M = 2 k + 1.$$

### BRIEF DESCRIPTION OF THE DRAWINGS

FIG. 1 is a plot of a prior climatological distribution of true error variances as revealed from 25,000 replicate systems for model 1 of Lorenz (2005).

FIGS. 2A-2D are plots depicting estimates of the probability density function (pdf) of true error variance (ordinate axis) given fixed values of ensemble variance (abscissa axis). FIGS. 2A and 2B show empirically derived pdfs while FIGS. 2C and 2D show the corresponding analytically derived inverse-gamma fits to these pdfs. Results are shown for effective ensemble sizes of M=2 and M=8.

FIG. 3 is a plot showing a comparison of the estimate of the climatological mean forecast error variance [symbol] σ² [symbol] from a “short” 400 time step experiment with the minimum (min), mean and maximum (max) values of [symbol] σ² [symbol] obtained from 7 independent “long” 400,000 time step experiments.

FIGS. 4A-4D are plots summarizing information from 7 independent attempts to retrieve the true values of the parameters var(σ²), a, σₘᵢₙ², and M using the measurement tools in accordance with the present invention, where the data were generated from 200,000 DA/forecast cycles with the Lorenz model and model error parameter q=0.0001, where FIGS. 4A, 4B 4C, and 4D give the values of the parameters var(σ²), a, σₘᵢₙ², and M, respectively.

FIGS. 5A-5D are plots showing the parameter retrieval results from the (q=0.0001, M=8), (q=0.001, M=8) and (q=0.01, M=8) parameter sets using the methods according) to the present invention, where the retrieved parameters var(σ²), a, σₘᵢₙ², and M are shown in FIGS. 5A, 5B, 5C, and 5D, respectively.

FIGS. 6A-6D are plots showing the parameter retrieval results for the (q=0.0001, M=2), (q=0.001, M=2) and (q=0.01, M=2) cases using the method according to the present invention, where retrieved parameters, var(σ²), a, σₘᵢₙ², and M are shown in FIGS. 6A, 6B, 6C, and 6D, respectively.

### DETAILED DESCRIPTION

The aspects and features of the present invention summarized above can be embodied in various forms. The following description shows, by way of illustration, combinations, and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

The state of reality is inaccurately known. A compelling way of expressing the degree of uncertainty is via a collection or ensemble of possible true states that are equally plausible with past observations and known physics. Ensembles of equally likely state estimates can be made for both past states and future states. When the ensemble state estimate pertains to a future state, it is often referred to as an ensemble forecast. The variance of the ensemble forecast is often used as a predictor of the error variance of the ensemble mean and/or of a higher resolution control forecast.

As noted above, over the last few decades, there has been an enormous amount of research and development of state estimation systems that utilize predictions of variances. It is non-trivial to measure variance prediction accuracy when the conditions associated with a variance prediction do not repeat themselves enough to obtain a condition-dependent sample large enough to compute the mean and variance of the sample In such circumstances, the condition-dependent variance is deemed to be “hidden” because it cannot be readily determined. The invention described in this patent solves this non-trivial problem with new tools derived from advanced statistical analysis. As described in more detail below, the present invention provides a computer-implemented method for measuring parameters that define prior and conditioned distributions of hidden variances from a long time series of (ensemble variance, forecast, observation) triplets. (sᵢ², xᵢ^{f}, yᵢ), i=1, 2, . . . , n from a single ensemble forecasting system. The invention also enables parameters such as the mean, variance, and minimum value of distributions of hidden variances to be measured for the first time.

The method in accordance with the present invention also clearly distinguishes between systematic and random aspects of variance prediction accuracy, even when the true variance is hidden by a lack of a sufficiently large sample size of appropriately conditioned realizations. The prior art methods of assessing variance prediction accuracy such as those described in Majumdar 2001 are incapable of distinguishing between systematic and random variance prediction errors, and so the method of the present invention provides a great deal of information that is absent from the Majumdar approach to assessing variance prediction accuracy.

As will be appreciated by one skilled in the art, a computer-implemented method for measuring the aforementioned parameters can be accomplished by executing one or more sequences of instructions contained in computer-readable program code read into a memory of one or more general or special-purpose computers configured to execute the instructions, wherein data from a single ensemble forecasting system, including data representative of a long time series of (innovation, ensemble variance) pairs, are transformed into data representative of the parameters [ [symbol] σ² [symbol] , var(σ²), σₘᵢₙ²] describing key aspects of the prior historical distribution of true error variances and data representative of the parameters [sₘᵢₙ², a, σₘᵢₙ², k⁻¹, and M] describing key aspects of the distribution of variance predictions given a true error variance.

In addition, although such parameters are described herein in the context of meteorological predictions and data analysis, the principles and methods described herein can also be applied to many other systems involving chaotic, non-reproducible elements, such as stock and commodity pricing, and oil reservoir estimation.

As described in more detail below, the present invention provides a computer-implemented instrument for measuring properties of distributions associated with hidden variances. As input, it requires a large set of condition dependent error variance predictions sᵢ², i=1, 2, . . . , n of the errors associated with a corresponding set of forecasts xᵢ^{f}, i=1, 2, . . . , n and a corresponding set of observations yᵢ, i=1, 2, . . . , n that can be used to measure the error in the forecasts.

Throughout this disclosure, [symbol] t [symbol] refers to the expected (mean) value of t, while [symbol] t|q [symbol] refers to the expected value of t given that q is held at a constant value. In addition, var(t) denote the variance of t while var(t|q) is used to denote the variance of t while q is held constant. Also, the term “climatological” is often used in this disclosure in connection with a prior historical distribution of variances, irrespective of whether or not the distribution relates to climatological phenomena.

As described in more detail below, the methods of the present invention measure the mean [symbol] σ² [symbol] , the minimum σₘᵢₙ², and the variance var(σ²), respectively, of a prior historical distribution ρ_{C}(σ²) of hidden error variances σ² associated with an input data set. The prior art measuring tool of Majumdar 2001 provides no information about these quantities. Indeed, our new invention is the first to be able to measure these quantities.

The invention also provides methods for estimating the mean [symbol] s²═σ² [symbol] , minimum sₘᵢₙ², and relative variance k⁻¹ of the distribution ρ_{L}(s²|σ²) of variance predictions s² given a fixed true error variance σ². The method gives [symbol] s²|σ² [symbol] —the mean variance prediction given a fixed σ² in the form a(σ²−σₘᵢₙ²)+sₘᵢₙ² where the parameters “a” and sₘᵢₙ² define the systematic component of error variance prediction. In addition, it gives the random or stochastic component of error variance prediction accuracy in terms of the relative variance k⁻¹. Thus, unlike the prior art method of Majumdar 2001, supra, the method for measuring variance prediction accuracy in accordance with the present invention explicitly distinguishes between and defines the systematic and random aspects of variance prediction inaccuracy.

The invention also provides methods for estimating the mean, minimum, and relative variance of the posterior distribution ρ_{P}(σ²|s²) of true variances given an imperfect error variance prediction s². Estimates of the relative variance and minimum of this distribution are completely absent from the Majumdar 2001 method for assessing variance prediction accuracy.

Thus, as described in more detail below, in accordance with the present invention, the parameters [ [symbol] σ² [symbol] , sₘᵢₙ², var(σ²), a, σₘᵢₙ², k⁻¹, and M] can be found from a long time series of (ensemble variance, forecast, observation) triplets. (sᵢ², xᵢ^{f}, yᵢ), i=1, 2, . . . , n from a single ensemble forecasting system. From this set of triplets, one can readily compute a corresponding time series of (innovation, ensemble-variance) data pairs (vᵢ, sᵢ²), i=1, 2, . . . , n data pairs where each innovation vᵢ=yᵢ−xᵢ^{f} is simply the difference between the verifying observation yᵢ and its corresponding forecast xᵢ^{f}.

As far as the inventors are aware, the methods of the present invention are the first ever developed for finding (i) the parameter var(σ²), representing the variance of a prior historical distribution ρ_{C}(σ²) of hidden error variances σ²; (ii) the parameter “a” defining the rate of change of the mean ensemble variance response to changes in true error variance; (iii) the parameter σₘᵢₙ² representing a minimum of true error variance; (iv) the parameter k⁻¹, representing the relative variance of the stochastic component of variance prediction error; and (v) the parameter M, representing the effective ensemble size.

Some brief background information will now be provided that is relevant to an understanding of the methods of the present invention.

The best available forecast of the ith observation is denoted xᵢ^{f}. In addition, the ith observation is denoted by yᵢ and is assumed to have known observation error variance Rᵢ, which may differ from one observation to the next. Corresponding to each forecast xᵢ^{f} of the ith observation is an error variance prediction sᵢ² and an innovation vᵢ=yᵢ−xᵢ^{f}, which gives the difference between the observed state and the forecast. In many applications, the variance prediction sᵢ² is an ensemble variance where the ensemble is a collection of draws from the predicted distribution of future states.

In theory, hidden variances could be revealed by replicate Earths. To see what we mean by this consider an infinite number of “replicate Earths” that each have the exact same evolving atmospheric-state (or, e.g., financial-market or oil well). Suppose that on each Earth, people try to predict some aspect of the atmospheric-state (or financial-market or oil-well) on their Earth. Assume that the same basic method used to make the prediction is the same on each of the replicate Earths but that the observations and models used on each of the replicate Earths are subject to differing random errors. The true instantaneous error variance can then be defined as the mean over all the replicate Earths of the square of the error of the forecast made on each of the replicate Earths. On each Earth, people know that their observations and models are imperfect and hence they use knowledge of these imperfections to attempt to predict the true instantaneous error variance of their prediction. However, since their knowledge of the error characteristics of their observations and models is imperfect, the prediction of instantaneous error variance made on each Earth must differ from the true instantaneous error variance. Our invention enables the relative error variance of the predictions of error variance about the true error variance to be measured without the artifice of replicate Earths.

To make this thought experiment more concrete, we created 25,000 pseudo-replicate Earths using a highly idealized model of the atmosphere due to Lorenz, see model 1 described in Lorenz, Edward N., 2005: Designing Chaotic Models. J. Atmos. Sci., 62, 1574-1587 (Lorenz 2005), and applied a widely used ensemble-data-assimilation and forecasting system, known as the Ensemble Transform Kalman Filter (ETKF) developed by Bishop et al., to it. See Bishop, C. H., B. J., Etherton and S. J. Majumdar, 2001: Adaptive Sampling with the Ensemble Transform Kalman Filter. Part I: Theoretical Aspects. Mon. Wea. Rev. 129, 420-436 (Bishop 2001), the entirety of which is hereby incorporated by reference into the present disclosure. Details of the model and ETKF used to produce the plots are given in Appendix A to Bishop, C. H., and E. A. Satterfield, 2013: Hidden error variance theory 1: Exposition and analytic model. Mon. Wea. Rev. 141, 1454-1468 (Bishop et al. 2013, Part 1), the entirety of which is hereby incorporated by reference into the present disclosure. For this case, the key quantity that the ETKF is attempting to predict is the forecast error variance of a control forecast conditioned on the current, true multi-variate state of the system.

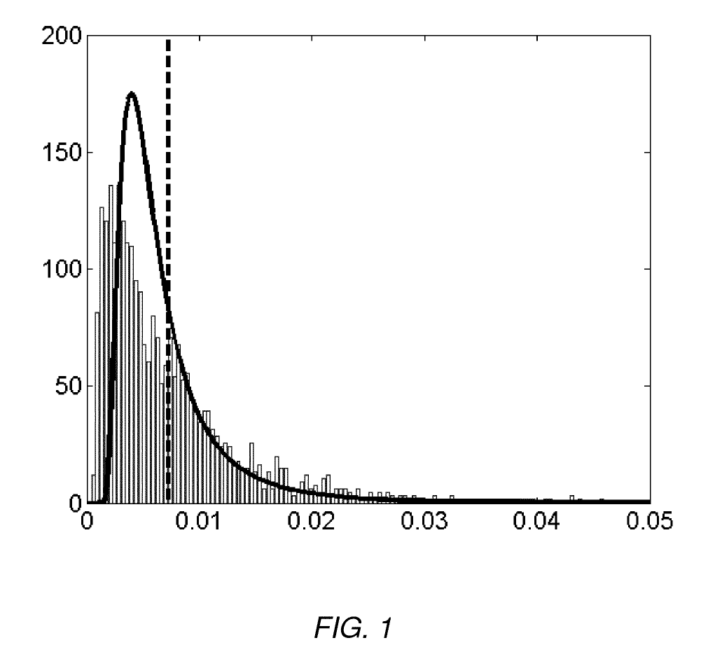

Using the replicate-Earth approach the inventors were able to compute the true instantaneous variance at every grid point and time step of our model. This created a prior historical or climatological distribution of true instantaneous error variances. FIG. 1 shows the prior climatological distribution of true instantaneous error variances obtained by using the replicate system technique for model 1 of Lorenz (2005). Bars show the probability density histogram of forecast error variances. Solid line shows the fit of an inverse Gamma probability density function (pdf) to the data. The fitting procedure ensures that the mean and the variance of the pdf and the data are the same. The thick dashed line marks the mean of both the pdf and the data. The figure also shows that the inverse-gamma distribution is a reasonable although imperfect fit to this distribution.

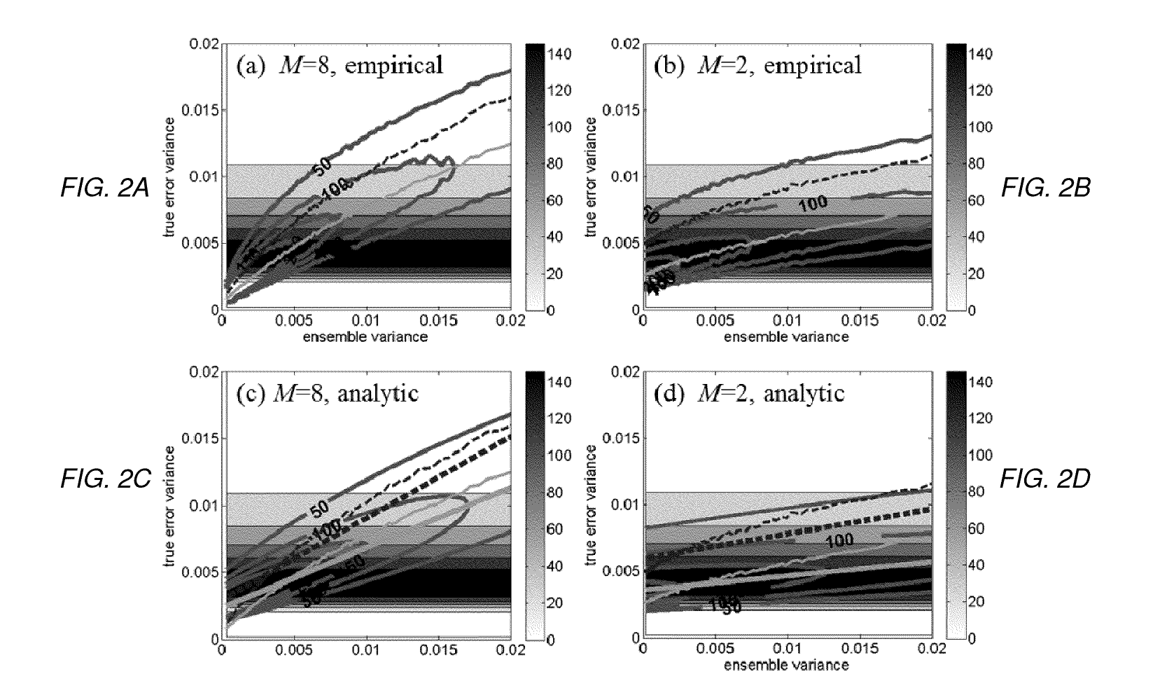

In this example, the variance prediction is given by the sample variance of an ensemble of M random draws from a distribution with a variance precisely equal to the variance of the ETKF variance prediction scheme. In this idealized example, the ETKF variances were found to closely approximate the true instantaneous error variance. When the random sample from distributions with variances equal to the accurate ETKF variance is small (M=2, FIG. 2B) the prediction from the sample variance is inaccurate and the mean of the posterior distribution of true instantaneous error variances, given the variance prediction, is a weakly varying function of the variance prediction. In addition, the variance of the posterior distribution of variances is only slightly smaller than the prior historical distribution of variances. However, when the sample size is larger (M=8, FIG. 2A), the mean of the posterior distribution of true instantaneous variances increases much more rapidly as the predicted variance increases. In this M=8 case, the variance of the posterior distribution is considerably narrower than the variance of the prior distribution.

FIGS. 2C and 2D approximate the empirically derived distributions by making the following assumptions.

The first assumption is that an inverse gamma probability distribution function (pdf) describes the prior historical pdf of instantaneous true error variances σ² and takes the form

$${ρ}_{prior} ( {σ}^{2} ) = \{ \begin{matrix}\frac{{β}^{α}}{Γ ( α )} {( {σ}^{2} - {σ}_{min}^{2} )}^{- α - 1} exp [ - ( \frac{β}{( {σ}^{2} - {σ}_{min}^{2} )} ) ] & for {σ}^{2} > {σ}_{min}^{2} \\ 0 & for {σ}^{2} \leq {σ}_{min}^{2}\end{matrix} \qquad ( 1 )$$

where σₘᵢₙ² is a minimum of the true instantaneous variance and α and β are parameters defining the prior historical mean [symbol] σ² [symbol] and variance var(σ²) of a hidden distribution of conditional variances σ² via the equations

$$\begin{matrix}α = \frac{{( 〈 {σ}^{2} 〉 - {σ}_{min}^{2} )}^{2}}{var ( {σ}^{2} )} + 2 \\ and & ( 2 a ) \\ β = ( 〈 {σ}^{2} 〉 - {σ}_{min}^{2} ) [ \frac{{( 〈 {σ}^{2} 〉 - {σ}_{min}^{2} )}^{2} + var ( {σ}^{2} )}{var ( {σ}^{2} )} ] . & ( 2 b )\end{matrix}$$

This prior historical pdf describes the historical frequency with which a range of true error variances actually occur.

The second assumption is that a gamma pdf describes the likelihood pdf of variance predictions s² given a true instantaneous error variance σ². That is,

$$L ( {s}^{2} \vert {σ}^{2} ) = \frac{1}{Γ ( k )} \frac{1}{( {s}^{2} - {s}_{min}^{2} )} {\{ \frac{k ( {s}^{2} - {s}_{min}^{2} )}{a ( {σ}^{2} - {σ}_{min}^{2} )} \}}^{k} exp \{ \frac{- k ( {s}^{2} - {s}_{min}^{2} )}{a ( {σ}^{2} - {σ}_{min}^{2} )} \} . \qquad ( 3 )$$

From the well-known properties of gamma functions, Equation (3) implies that the mean and relative variance of the distribution of ensemble variances given σ² are, respectively

$$\begin{matrix}〈 {s}^{2} \vert {σ}^{2} 〉 = a ( {σ}^{2} - {σ}_{min}^{2} ) + {s}_{min}^{2} \\ and & ( 4 a ) \\ \frac{var [ ( {s}^{2} - {s}_{min}^{2} ) \vert {σ}^{2} ]}{{[ a ( {σ}^{2} - {σ}_{min}^{2} ) ]}^{2}} = \frac{1}{k} . & ( 4 b )\end{matrix}$$

Via Bayes' theorem, Equations (1) and (3) imply that the posterior distribution of true instantaneous variances given an imperfect variance prediction s² takes exactly the same form as in Equation (1) except that the posterior α and β parameters are given by

αₚₒₛₜ=α+k and βₚₒₛₜ=[(s²−sₘᵢₙ²)k/a]+β, (5)

while the mean [symbol] σ²|s² [symbol] and variance var(σ²|s²), respectively, of the distribution of true error variances given the ensemble variance s² are given by

$$〈 {σ}^{2} \vert {s}^{2} 〉 = {σ}_{min}^{2} + \frac{{β}_{post}}{{α}_{post} - 1} \\ and \\ var ( {σ}^{2} \vert {s}^{2} ) = \frac{{β}_{post}^{2}}{{( {α}_{post} - 1 )}^{2} ( {α}_{post} - 2 )} , \qquad ( 6 )$$

Note that Equation (6) assumes that the distribution of error variances given an imperfect variance prediction s² is an inverse gamma distribution.

The elliptical contours on FIGS. 2C and 2D depict the posterior inverse gamma distribution of true error variances as a function of s² that one obtains by using the αₚₒₛₜ and βₚₒₛₜ from Equation (5) in the definition of an inverse gamma distribution given by Equation (1). The values of α and β used in Equation (5) were determined using Equation (2) from the variance, mean, and minimum of the prior historical distribution of σ² obtained from the replicate Earth experiment. The value of a used in Equation (5) was given by the slope of the line of best fit to data points with the error variance σ² on the abscissa axis and mean ETKF variance on the ordinate axis. The parameter sₘᵢₙ² was set equal to the minimum of the complete set of ETKF variances obtained in the ETKF experiments.

These estimation methods gave numerical values for [symbol] σ² [symbol] , sₘᵢₙ², var(σ²), a, and σₘᵢₙ² described above, i.e.,

[ [symbol] σ² [symbol] ,sₘᵢₙ²,var(σ²),a,and σₘᵢₙ²]=[7.2×10⁻³,1.6×10⁻⁴,4.1×10⁻⁵,1.03,5.5×10⁻⁴].

The relative variance parameter k⁻¹ was obtained using

$$k = \frac{2}{M - 1}$$

with M=8 for FIGS. 2C and M=2 for FIG. 2D.

The high degree of similarity between the contours of FIGS. 2A and 2C (M=8 case) and for FIGS. 2B and 2D (M=2 case) demonstrate that the analytical model which defines the relationship between imperfect variance predictions and instantaneous variances in terms of inverse gamma and gamma distributions is qualitatively correct.

FIGS. 1 and 2 serve to illustrate (a) the existence of instantaneous true error variances conditioned on a state that may never occur again (because of the aperiodic nature of the non-linear chaotic system) (b) the existence of a prior historical distribution of true but hidden error variances, and (c) the distribution of instantaneous true error variances that are associated with imperfect variance predictions. However, they were derived by using the artifice of replicate forecast/analysis systems to compute the defining parameters of the variance distribution [ [symbol] σ² [symbol] , sₘᵢₙ², var(σ²), a, σₘᵢₙ², k⁻¹, and M].

The present invention enables these parameters to be estimated without the need of the artifice of replicate systems.

As described above, variance forecasts are usually made in conjunction with a forecast of the mean of the future distribution of interest, where corresponding to each forecast xᵢ^{f} of the ith observation is a variance prediction sᵢ² and an innovation vᵢ=yᵢ−xᵢ^{f} which represents the difference between the observation and the forecast of the observation. Consequently, It is straightforward to use a probabilistic forecasting system to create a long data record of (innovation, ensemble-variance) data pairs (vᵢ, sᵢ²), i=1, 2, . . . , n. In the following description, it is assumed that both forecasts and observations are unbiased so that [symbol] v [symbol] =0. If there are known biases in either the forecasts or observations these should be removed before the innovation is computed. If there are unknown biases in either the forecasts or observations that result in the mean innovation not being equal to zero <v>≠0 then this bias should be removed from each innovation to obtain a bias corrected set of data pairs (vᵢ, sᵢ²), i=1, 2, . . . , n for which [symbol] v [symbol] =0.

Of the parameters [ [symbol] σ² [symbol] , sₘᵢₙ², var(σ²), a, σₘᵢₙ², k⁻¹, and M], the parameters [symbol] σ² [symbol] and sₘᵢₙ² can readily be recovered.

To be specific, using a computer programmed with the appropriate instructions, [symbol] σ² [symbol] , the mean [symbol] σ² [symbol] of a prior historical distribution ρ_{C}(σ²) of hidden error variances σ² can be can be found by a method that includes the following steps performed by the computer:

(i) receive a set of (innovation, ensemble-variance) data pairs (vᵢ, sᵢ²), i=1, 2, . . . , n from a single ensemble forecasting system;
(ii) receive data representing the true observation error variances Rᵢ for each ith observation; and
(iii) compute

[symbol]

σ² [symbol] = [symbol] vᵢ²−Rᵢ [symbol] . (7)

Similarly, sₘᵢₙ², the prior historical minimum of variance predictions can also easily be found can be found by a method that includes the following steps performed by the computer:

(i) receive a large set of (innovation, ensemble-variance) data pairs (vᵢ, sᵢ²), i=1, 2, . . . , n from a single ensemble forecasting system; and
(ii) find the minimum value of sᵢ² over this data set and set sₘᵢₙ² equal to this value; in other words,

sₘᵢₙ²=min(sᵢ²). (8)

As noted above, as far as the inventors are aware, the methods of the present invention are the first ever developed for finding (i) the parameter var(σ²), representing the variance of a prior historical distribution ρ_{C}(σ²) of hidden error variances σ²; (ii) the parameter “a” defining the rate of change of the mean ensemble variance response to changes in true error variance; (iii) the parameter σₘᵢₙ² representing a prior historical minimum of true error variance; (iv) the parameter k⁻¹, representing the relative variance of the stochastic component of variance prediction error; and (v) the parameter M, representing the effective ensemble size.

The methodology for finding each of these parameters in accordance with the present invention is set forth below.

### The Parameter Var(σ²)

In accordance with the present invention, using computer programmed with the appropriate instructions, the parameter var(σ²), the variance of a prior historical distribution ρ_{C}(σ²) of hidden error variances, can be found by a method that includes the following steps performed by the computer:

(i) receive a set of (innovation, ensemble-variance) data pairs (vᵢ, sᵢ²), i=1, 2, . . . , n from a single ensemble forecasting system;
(ii) receive data representing the true error variances Rᵢ for each ith observation;
(iii) compute [symbol] v⁴ [symbol] , the mean of the 4^{th} power of the each innovation vᵢ;
(iv) compute [symbol] σ² [symbol] , the mean of the prior historical distribution of instantaneous variances, where [symbol] σ² [symbol] = [symbol] v²−R [symbol] as described above;
(vi) compute [symbol] R [symbol] , the mean of the true observation error variances Rᵢ;
(vii) compute var(R), the variance of the true observation error variances Rᵢ; and
(vii) using the thus-determined [symbol] v⁴ [symbol] , [symbol] σ² [symbol] , [symbol] R [symbol] , and var(R), compute the parameter var(σ²), where

$$\begin{matrix}var ( {σ}^{2} ) = \frac{〈 {v}^{4} 〉}{3} - {( 〈 {σ}^{2} 〉 + 〈 R 〉 )}^{2} - var ( R ) \\ = {( 〈 {σ}^{2} 〉 + 〈 R 〉 )}^{2} [ \frac{kurtosis ( v ) - 3}{3} ] - var ( R ) .\end{matrix} \qquad ( 9 )$$

Equation (9) assumes that the innovation vᵢ is a stochastic normally distributed random process given a flow dependent instantaneous variance σ² and a true observation error variance Rᵢ. In many applications this is a very good assumption. It will be appreciated by those skilled in the art that in some embodiments, one or more of [symbol] v⁴ [symbol] , [symbol] σ² [symbol] , [symbol] R [symbol] , and var(R) may already have been found, and in those embodiments, the computer can simply receive that data and use those previously found values in finding var(σ²) using Equation (9).

### The Parameter a

The present invention also provides a method for finding the parameter “a” that gives the rate of change of the mean ensemble variance response to changes in true error variance.

Thus, in accordance with the present invention, using a computer programmed with the appropriate instructions, the parameter a can be found by a method that includes the following steps performed by the computer:

(i) receive a set of (innovation, ensemble-variance) data pairs (vᵢ, sᵢ²), i=1, 2, . . . , n from a single ensemble forecasting system;
(ii) receive the estimate of var(σ²) obtained from Equation (9);
(iii) compute covar(v², s²), the covariance of v² and s²; and
(iv) using covar(v², s²) and var(σ²) found as described above with respect to Equation (9), find a, where

$$a = \frac{covar ( {v}^{2} , {s}^{2} )}{var ( {σ}^{2} )} . \qquad ( 10 )$$

As in the method for finding var(σ²) described above, in some embodiments, covar(v², s²) can already have been found, and in those embodiments, the computer can simply receive that data and data of var(σ²) and find a using Equation (10).

The Parameter σₘᵢₙ²

The present invention further provides a method in which the minimum possible true variance σₘᵢₙ² of prior historical distribution ρ_{C}(σ²) of hidden variances can be measured. Thus, in accordance with the present invention, using a computer programmed with the appropriate instructions, σₘᵢₙ² can be found by a method that includes the following steps performed by the computer:

(i) receive a set of (innovation, ensemble-variance) data pairs (vᵢ, sᵢ²), i=1, 2, . . . , n from a single ensemble forecasting system;
(ii) compute [symbol] σ² [symbol] , sₘᵢₙ², and a as described above using Equations (7), (8), and (10) above, respectively;
(iii) compute [symbol] s² [symbol] , the mean of the variance predictions; and
(iv) compute σₘᵢₙ² from [symbol] σ² [symbol] , sₘᵢₙ², a, and [symbol] s² [symbol] , using

$${σ}_{min}^{2} = 〈 {σ}^{2} 〉 - \frac{〈 {s}^{2} 〉 - {s}_{min}^{2}}{a} . \qquad ( 11 )$$

One skilled in the art will readily recognize that [symbol] s² [symbol] can be found using any appropriate ordinary method known in the art. In addition, similar to the methods for finding var(σ²) and a described above, in some embodiments, one or more of [symbol] σ² [symbol] , sₘᵢₙ², a, and [symbol] s² [symbol] may already have been found, and in such cases, determined by the same or by another appropriate programmed computer, and so data corresponding to those already-determined parameters can be input into the computer along with the data of the (innovation, ensemble-variance) data pairs (vᵢ, sᵢ²), i=1, 2, . . . , n, with σₘᵢₙ² being found by the computer using Equation (11) above.

The Parameters k⁻¹ and M

Finally, the present invention provides a method for finding an effective ensemble size M, by measuring k⁻¹, representing the relative variance of the stochastic component of variance prediction error. Thus, in accordance with the present invention, using a computer programmed with the appropriate instructions, k⁻¹, the relative variance of the variance prediction error, can be found by a method that includes the following steps performed by the computer:

(i) receive a set of (innovation, ensemble-variance) data pairs (vᵢ, sᵢ²), i=1, 2, . . . , n from a single ensemble forecasting system;
(ii) receive data representing the true error variances Rᵢ for each ith observation;
(iii) compute var(s²), the variance of the prior historical distribution of predicted variances;
(iv) compute [symbol] σ² [symbol] , var(σ²), a, and σₘᵢₙ² using Equations (7), (9), (10), and (11) described above; and
(v) compute k⁻¹, where

$${k}^{- 1} = \frac{1}{k} = \frac{var ( {s}^{2} ) - {a}^{2} var ( {σ}^{2} )}{{a}^{2} [ {( 〈 {σ}^{2} 〉 - {σ}_{min}^{2} )}^{2} + var ( {σ}^{2} ) ]} \qquad ( 12 )$$

One skilled in the art would appreciate that var(s²) may be computed using any appropriate method known in the art. In addition, as described above, in some embodiments, any one or more of σ², Rᵢ, var(s²), [symbol] σ² [symbol] , var(σ²), a, and σₘᵢₙ² may already have been found, and in such embodiments those data can be input into the computer along with the data of the (innovation, ensemble-variance) data pairs (vᵢ, sᵢ²)=1, 2, . . . , n, with k⁻¹ being found by the computer using Equation (12) above.

Once k⁻¹ is found, in accordance with the present invention, an appropriately programmed computer can trivially find the effective ensemble size M, where

$$M = 2 k + 1 = \frac{2}{{k}^{- 1}} + 1. \qquad ( 13 )$$

Thus, Equations (7)-(12) can be used to find the parameters [ [symbol] σ² [symbol] , sₘᵢₙ², var(σ²), a, σₘᵢₙ², and k⁻¹], while Equation (13) relates effective ensemble size M to the parameter k⁻¹ found using Equation (12). The derivation of Equations (7)-(12) and a proof that they provide accurate estimations of the parameters [ [symbol] σ² [symbol] , sₘᵢₙ², var(σ²), a, σₘᵢₙ², and k⁻¹] is given in Appendix A of Bishop, C. H., E. A. Satterfield, and K. Shanley, 2013: Hidden error variance theory 2: An instrument that reveals hidden error variance distributions from ensemble forecasts and observations. Mon. Wea. Rev. 141, 1469-1483 (Bishop et al. 2013, Part 2), the entirety of which is hereby incorporated by reference into the present disclosure. Details regarding Equation (13) and the relationship between M and k⁻¹ can be found in Appendix B to Bishop et al. 2013, Part 1, supra. These derivations and details will not be repeated here in the interests of brevity.

As described below, Equations (7)-(12) can also be used to find the prior, likelihood, and posterior analytic pdfs ρₚᵣᵢₒᵣ(σ²), L(s²|σ²), and ρₚₒₛₜ(σ²|s²) with the plots in FIGS. 2A-2D showing that these pdfs are consistent with the test data generated using replicate systems.

The above analysis gives three measures of the utility of a flow dependent variance predictor such as an ensemble variance.

The first is a measure of the relative variance of the prior historical distribution of instantaneous variances:

$$\frac{1}{( α - 1 )} = \frac{var ( {σ}^{2} )}{{( 〈 {σ}^{2} 〉 - {σ}_{min}^{2} )}^{2} + var ( {σ}^{2} )} ⇒ \frac{1}{( α - 2 )} = \frac{var ( {σ}^{2} )}{{( 〈 {σ}^{2} 〉 - {σ}_{min}^{2} )}^{2}} . \qquad ( 14 )$$

When this measure is large (small), the potential value of imperfect flow dependent variance prediction is large (small). As far as the inventors are aware, our invention provides the first practical instrument for measuring this quantity.

The second new measure is the relative variance of the variance prediction s² given a fixed instantaneous variance σ². Provided that the likelihood pdf L(s²|σ²) of predicted variances given a true variance is created by a stochastic process of the form

(s²−sₘᵢₙ²)=a(σ²−σₘᵢₙ²)+ξ, (15)

where ξ is random and [symbol] ξ [symbol] = [symbol] ξσ² [symbol] =0,
the relative variance of the likelihood pdf L(s²|σ²) is given by Equation (4b) above, which can be rewritten in the form

$$\frac{1}{k} = \frac{2}{M - 1} = \frac{var [ ( {s}^{2} - {s}_{min}^{2} ) \vert {σ}^{2} ]}{{[ a ( {σ}^{2} - {σ}_{min}^{2} ) ]}^{2}} = \frac{var ( {s}^{2} \vert {σ}^{2} )}{{[ a ( {σ}^{2} - {σ}_{min}^{2} ) ]}^{2}} . \qquad ( 16 )$$

while its mean is given by a(σ²−σₘᵢₙ²)+sₘᵢₙ². Equation (16) provides a concise description of the random aspect of variance prediction inaccuracy.

The third measure is of the systematic aspect of variance prediction accuracy, which is given by

[symbol]

s²|σ² [symbol] −σ²=a(σ²−σₘᵢₙ²)+sₘᵢₙ²−σ²=(a−1)σ²+(sₘᵢₙ²−aσₘᵢₙ²). (17)

Hence, (a−1) gives the rate of change of the mean error ( [symbol] s²|σ² [symbol] −σ²) with the true error variance σ² while (sₘᵢₙ²−aσₘᵢₙ²) gives the part of the systematic error that is independent of changes in σ².

Equation (15) above can be rearranged to obtain a de-biased flow-dependent variance prediction

$${σ}_{n}^{2} = \frac{{s}^{2}}{a} - ( \frac{{s}_{min}^{2}}{a} - {σ}_{min}^{2} ) \qquad ( 18 )$$

which is unbiased in the sense that its average value for a fixed σ² is precisely equal to σ². If the relative variance of L(s²|σ²) is very small (large) then the approximation in Equation (18) is very accurate (inaccurate).

Note that the relative-variance-measure k⁻¹ of the ability of the (unbiased) ensemble variance to predict true instantaneous variance is independent of (a) the accuracy of the forecast x^{f} and (b) the bias [symbol] s²−σ²|σ² [symbol] of the variance predictor. In contrast, as far as the inventors of the present invention are aware, existing measures of probabilistic forecasting accuracy such as threat score, Brier score, mutual information, and ROC curve are highly sensitive to both the accuracy of x^{f} and the bias of the flow dependent variance prediction. Our new measurement of variance prediction accuracy can be expressed either in terms of the relative variance k⁻¹ or an effective ensemble size M (see Equation 13).

One of the areas where the method of the present invention is likely to be used is in the tuning of hybrid forecast error covariance models that linearly combine flow dependent forecast error covariance information from a real time ensemble forecast with a prior historical estimate of forecast error covariances. Forecast error covariance models are a foundational component of data assimilation schemes that fuse information from short term forecasts with recent observations. Such schemes require a single “best estimate” of the error variance given an ensemble variance. The mean of the posterior distribution of forecast error variances is “best” in the sense that it minimizes the mean square deviation of the estimate from the true value. In Bishop et al., 2013, Part 2, supra, it is shown that the posterior mean [symbol] σ²|s² [symbol] over all realizations of the error variance given a fixed value of s² is given by

$$〈 {σ}^{2} \vert {s}^{2} 〉 = \frac{k}{k + ( α - 1 )} {σ}_{n}^{2} + \frac{α - 1}{k + ( α - 1 )} 〈 {σ}^{2} 〉 . \qquad ( 19 )$$

where

$${σ}_{n}^{2} = [ \frac{{s}^{2}}{a} + ( {σ}_{min}^{2} - \frac{{s}_{min}^{2}}{a} ) ]$$

is a debiased ensemble based estimate of forecast error variance and [symbol] σ² [symbol] is the mean of the prior historical distribution of error variances.

While Equation (19) strictly pertains to variances, for some systems it is likely that it will also be usefully applied to covariances. Hence,

$${P}_{Hybrid}^{f} = \frac{k}{k + α - 1} \{ [ \frac{{P}_{Ensemble}^{f}}{a} ] + [ {σ}_{min}^{2} - \frac{{s}_{min}^{2}}{a} ] {\tilde{Q}}_{climatology}^{min} \} + [ \frac{( α - 1 )}{k + α - 1} ] {P}_{climatology}^{f} \qquad ( 20 )$$

is likely to be a useful ansatz, that is, an educated guess that is later verified by results, for the optimal weights for hybrid error covariance models, P_{Hybrid}^{f} that best approximate the true flow dependent forecast error covariance matrix. In Equation (20), P_{Ensemble}^{f} is a flow dependent estimate of the forecast error covariance matrix that is likely to be generated from an ensemble forecast, P_{climatology}^{f} is a climatological estimate of the forecast error covariance matrix, and \tilde{Q}_{climatology}^{min} is a correlation matrix giving the structure of the smallest true conditional forecast error covariance matrix that occurs in the system.

Provided that

$${[ \frac{{P}_{Ensemble}^{f}}{a} ]}^{- 1} [ {σ}_{min}^{2} - \frac{{s}_{min}^{2}}{a} ] {\tilde{Q}}_{climatology}^{min} \approx 0 \qquad ( 21 )$$

is small, Equation (20) can be approximated by

$${P}_{Hybrid}^{f} = \frac{1}{a} [ \frac{k}{k + a - 1} ] {P}_{Ensemble}^{f} + [ \frac{( α - 1 )}{k + α - 1} ] {P}_{climatology}^{f} = {w}_{E} {P}_{Ensemble}^{f} + {w}_{C} {P}_{climatology}^{f} , \qquad ( 22 a )$$

where the weights w_{E} and w_{C} for the ensemble-based and climatological short range forecast error covariances, respectively, are

$$\begin{matrix}{w}_{E} = \frac{1}{a} [ \frac{k}{k + α - 1} ] \\ and & ( 22 b ) \\ {w}_{c} = [ \frac{( α - 1 )}{k + α - 1} ] . & ( 22 c )\end{matrix}$$

Once the parameters described above are found, they can be used to find other characteristics of forecast error variances. For example, w_{E} can be estimated as

$${w}_{E} = \frac{1}{a} \frac{k}{( k + α - 1 )} = \frac{covar ( {v}^{2} , {s}^{2} )}{var ( {s}^{2} )} . \qquad ( 23 )$$

See Bishop et al. 2013, Part 2, supra.

Once w_{E} is defined, the requirement that the climatological average of hybrid variance be equal to the observed climatological average of forecast error variance gives w_{C}, i.e.,

$$\begin{matrix}〈 {σ}^{2} 〉 = {w}_{E} 〈 {s}^{2} 〉 + {w}_{C} 〈 {σ}^{2} 〉 & ( 24 a ) \\ ⇒ {w}_{C} = \frac{〈 {σ}^{2} 〉 - {w}_{E} 〈 {s}^{2} 〉}{〈 {σ}^{2} 〉} . & ( 24 b )\end{matrix}$$

Equations (24a) and (24b) assume that the variance elements in P_{climatology}^{f} are equal to the climatological, that is, the prior historical, average of true error variance [symbol] σ² [symbol] of their corresponding variables. However, in practice, the static covariance matrix used in place of P_{climatology}^{f} may have inaccurate variance elements which we will generically denote as [symbol] σ² [symbol] _{guess}, where it is understood that, in general, [symbol] σ² [symbol] _{guess}≠ [symbol] σ² [symbol] = [symbol] v²−R [symbol] . In such a case, the requirement in Equations (24a) and (24b) gives

$$\begin{matrix}〈 {σ}^{2} 〉 = {w}_{E} 〈 {s}^{2} 〉 + {w}_{C} {〈 {σ}^{2} 〉}_{guess} & ( 25 a ) \\ ⇒ {w}_{C} = \frac{〈 {σ}^{2} 〉 - {w}_{E} 〈 {s}^{2} 〉}{{〈 {σ}^{2} 〉}_{guess}} . & ( 25 b )\end{matrix}$$

### Tests of the Invention

We next examine whether the parameters [var(σ²), a, σₘᵢₙ², k⁻¹] can be found in accordance with the present invention using Equations (7)-(12) above without the use of replicate systems.

### Tests Based on Long-Time Series of (Innovation, Ensemble-Variance) Pairs

In the background section of this disclosure, the posterior distribution of true instantaneous variances given a variance prediction together with the associated parameters [var(σ²), a, σₘᵢₙ², k⁻¹] was revealed by running 25,000 replicate systems all having the same true state but differing realizations of model and observation error. The set-up allowed us to collect 25,000 independent realizations of forecast error for each flow which, in turn, allowed us to accurately compute the true flow dependent instantaneous variance σ² that would otherwise be hidden. From these realizations of σ², we were able to estimate the four parameters [var(σ²), a, σₘᵢₙ², and k⁻¹].

The method of the present invention, as reflected in Equations (7)-(12), enables us to obtain these parameters, not from the impractical artifice of replicate systems, but from a long time series (vᵢ, sᵢ²), i=1, 2, . . . , n of (innovation, ensemble-variance) pairs from a single ensemble forecasting system. To test this claim, we extended one of the data assimilation and forecast runs from the background section until we had a long time series of (innovation, ensemble-variance) pairs. By applying Equations (7)-(13) to the data obtained from this long run, we obtained values for [var(σ²), a, σₘᵢₙ², k⁻¹, and M] which we then compared with the corresponding values obtained by applying the replicate system approach to a much shorter run.

The non-linear model used for the long run and replicate system short run was a 10-variable version of the Lorenz (1996) model, see Lorenz, E., 1996: Predictability—a problem solved, Proceedings on predictability, held at ECMWF, 4-8 September, 1995; and the Lorenz (2005) model 1, see Lorenz, Edward N., 2005: Designing Chaotic Models, J. Atmos. Sci., 62, 1574-1587 (Lorenz 2005) Imperfection was introduced into the model by adding noise q of the variance to the initial condition before each forecast is made. The data assimilation scheme was an adaptation of the Ensemble Transform Kalman Filter developed by Bishop et al. 2001 that accounts for model error. See Bishop et al. 2001, supra. Details regarding the data assimilation scheme used to test Equations (7)-(13) are set forth in Appendix A to Bishop and Satterfield. 2013, Part 1, supra, and will not be set forth here in the interests of brevity.

The time step used in the model is analogous to a 6-hour time step in an atmospheric model (Lorenz 2005, supra), with data assimilation being performed every two time steps (˜12 hours). The short run that used replicate systems was comprised of 400 time steps and 200 corresponding data assimilation cycles. Results associated with the first 50 time steps were removed to allow for system “spin-up.” The long run was the same as the short run except it started from a different initial condition and used differing random realizations of forecast and model error and it was run for 400,100 time steps, the first 100 of which were discarded. This approach left 200,000 observation times for use in constructing the archive of (innovation, ensemble-variance) pairs. Since 10 variables are observed at each DA time, the long run yields 2×10⁶ (innovation, ensemble-variance) pairs from which to attempt parameter recoveries using Equations (7)-(13).

To check the sensitivity of the parameter recoveries obtained to random variations, the long run and associated parameter recoveries were independently repeated 7 times using differing random realizations of the initial, observation and model errors.

Comparison of ETKF variance with the true instantaneous error variance obtained from the replicate systems experiment showed it to be an extremely accurate predictor of error variance in our idealized system in which all sources of error were known and accurately accounted for. However, such near perfect variance predictions are unattainable in real systems because of unknown sources of variance. To create (more realistic) imperfect ensemble variances, it was necessary for us to generate synthetic ensemble variances from the ETKF variances that were less accurate than the ETKF variance. For each of the 7 long runs, we did this by first finding the minimum value of ETKF ensemble forecast error variance over the 400,000 time step test period over all 7 runs and defined this value to be sₘᵢₙ². This approach gave sₘᵢₙ²=min(s_{ETKF}²)=1.63×10⁻⁴ where s_{ETKF}² is a realization from the set of ETKF variances produced during the long run. Second, we took M random samples from a normal distribution with mean zero and variance equal to (s_{ETKF}²−sₘᵢₙ²), computed the sample variance of the M member random draw and then added this sample variance to sₘᵢₙ² to obtain our final degraded ensemble variance. In summary, degraded ensemble variances were obtained using

s²=sₘᵢₙ²+η (26)

where η is a variance drawn from a gamma distribution having a mean (s_{ETKF}²−sₘᵢₙ²) and relative variance

$${k}^{- 1} = \frac{2}{( M - 1 )} .$$

This approach produces distributions of sample variances that would be identical to those given by Equations (3) and (15) if the ETKF variance was equal to the true flow dependent error variance. (In actuality, the ETKF variance is only approximately equal to the true error variance).

In additional testing of the method in accordance with the present invention, we considered two distinct M values: M=2 and M=8, which give relatively inaccurate and accurate ensemble variances, respectively. For each of the seven 200,000 DA cycle periods, we used Equation (19) to produce three independent sets of degraded ensemble variances for both the M=2 and M=8 cases. This approach gave 7 strictly independent sets and 7×3=21 quasi-independent sets of (innovation, ensemble-variance) pairs.

In our system, the ensemble variances have been designed to never fall below min (s_{ETKF}²) so we simply set sₘᵢₙ²=min (s_{ETKF}²) over the 7 independent trials. This approach retrieved a value for sₘᵢₙ² that was exactly the same as that used to generate the ensemble variances. Experiments using a sₘᵢₙ² value 5 times greater than this value showed that the recovery of the other parameters is not very sensitive to the accuracy with which sₘᵢₙ² is estimated.

An assumption of our idea of comparing the parameters retrieved by applying our invention to a large archive of (innovation, ensemble-variance) pairs produced by the 400,000 time step run is that the climatological distribution of true error variances and the likelihood distribution of ensemble variances are the same for the “short” 400 time step period considered earlier as the 400,000 time step period considered here. One crude indicator of the validity of this assumption is the degree of similarity between the estimate of mean forecast error variance [symbol] σ² [symbol] from the initial 400 time step period and the longer 400,100 time step period.

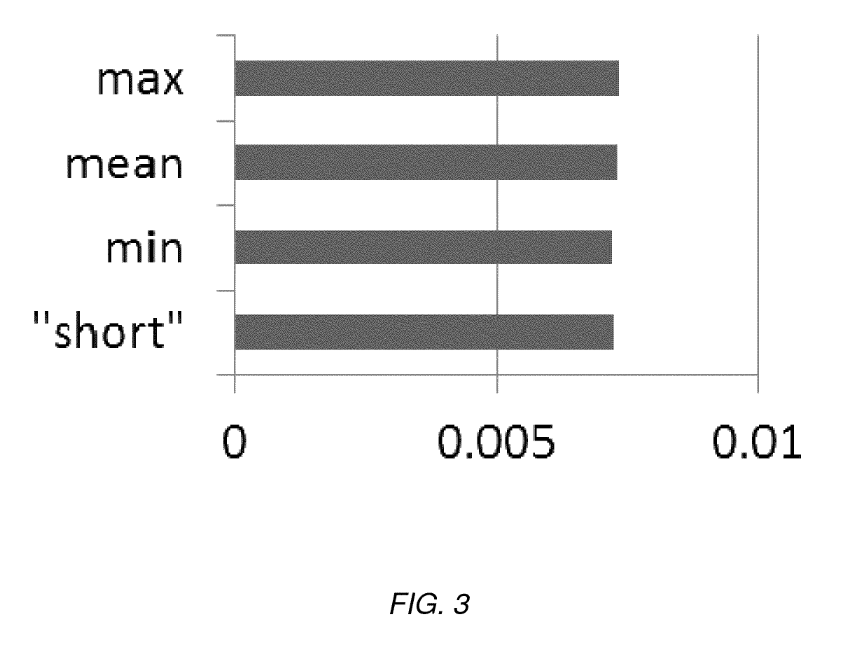

FIG. 3 illustrates this point. The plot in FIG. 3 shows a comparison of the estimate of the climatological mean forecast error variance [symbol] σ² [symbol] from the “short” 400 time step experiment with the minimum (min), mean and maximum (max) values of [symbol] σ² [symbol] obtained from the 7 independent “long” 400,000 time step experiments and shows that the value of [symbol] σ² [symbol] obtained from the “short” 400 time step run is almost exactly the same as the mean of the values obtained from the 7 “long” 400,000 time step runs.

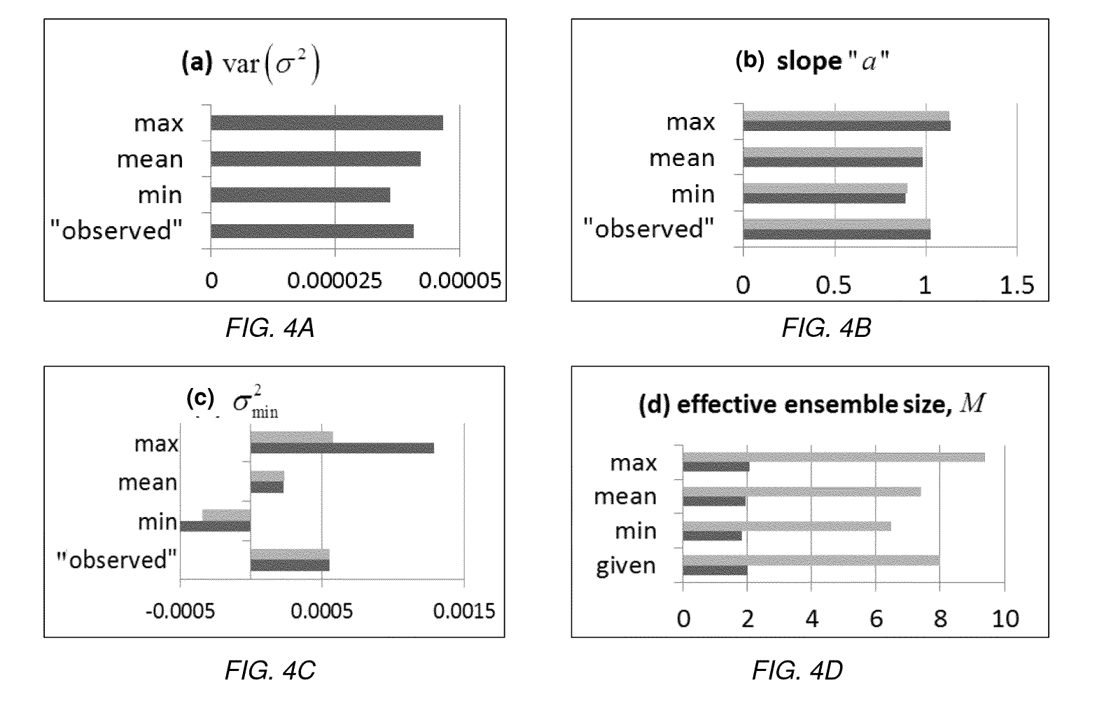

The accuracy of the parameters var(σ²), a, σₘᵢₙ², and M obtained from Equations (7)-(13) can be seen from the plots shown in FIGS. 4A-4D. The plots in each of FIGS. 4A-4D summarizes information from 7 independent attempts to retrieve the parameters from 200,000 DA/forecast cycles with the Lorenz model and model error parameter q=0.0001. The values marked as “observed” are the values obtained from the 175 DA cycles of the 25,000 “replicate systems” described in Part 1. The black and grey bars shown in FIGS. 4B, 4C, and 4D correspond to given values of M=2 and M=8 cases, respectively. The “given” ensemble sizes in FIG. 4D are the random sample ensemble sizes used to degrade the quality of the ETKF ensemble variance. The values marked as min, mean and max are the minimum, mean and maximum of the values retrieved from 7 completely independent sets of 200,000 DA cycles.

The bars marked “observed” in FIGS. 4A, 4B 4C, and 4D give the values of the parameters var(σ²), a, σₘᵢₙ², and M, respectively, revealed by the “short” replicate system experiment. These plots allow the observed values to be compared with the minimum, mean and maximum values retrieved from the 7×3 long sets of (innovation, ensemble variance) pairs using Equations (7)-(13).

FIGS. 4A and 4B show that for the parameters var(σ²) and a, the mean of the values from the 7 independent experiments is very close to the observed value. FIG. 4C shows that the range of retrievals of σₘᵢₙ² obtained from individual runs is quite large. (The minimum retrieved value is actually negative!). The mean value from the 7 independent trials is significantly smaller than the “observed” value. However, this “observed” value was obtained by setting σₘᵢₙ² equal to the smallest of the 1,750 realizations of σ² obtained in the replicate system experiment. Since it seems likely that even smaller values of σ² would be obtained if this experiment were run for a longer period of time, it is highly probable that the value of σₘᵢₙ² obtained by this method is an overestimate of the true climatological minimum of instantaneous forecast error variance. Hence, the retrieved σₘᵢₙ² value may be more accurate than that suggested by FIG. 4C.

FIG. 4D shows that despite the aforementioned uncertainties in the retrieval of σₘᵢₙ², Equations (7)-(13) yield an effective ensemble size M=2k−1 very close to the “given” values of M that were used to generate the ensemble variances. In both the M=2 case and the M=8 case, the retrieved values of M are slightly smaller than the given values. A possible explanation for this is that the ETKF variances exhibit (slight) stochastic variations around the true error variance. Hence, fluctuations of s² about the true flow dependent error variance are not only caused by the size of the random sample used to generate s² from the ETKF variance but also from the inherent fluctuations of the ETKF variances about the true error variance. From this perspective, one would expect the recovered effective ensemble sizes to be smaller than the given ensemble sizes. FIG. 4D is consistent with this expectation.

In summary, the plots in FIGS. 4A-4D show that Equations (7)-(13) can retrieve the parameters var(σ²), a, σₘᵢₙ², and M from long time series of (innovation, ensemble-variance) pairs, producing parameters that are very close to those obtained from the replicate system approach. These parameters can then be used to represent the posterior pdf of true error variances given an ensemble variance (FIG. 2) in terms of an inverse-gamma pdf.

### Tests Based on Synthetic Data

To further test whether Equations (7)-(13) can infer the correct prior, likelihood, and posterior distributions of forecast error variance, in this subsection, the inventors applied Equations (7)-(13) to synthetic data to see if they can precisely recover the parameters used to generate the synthetic data.

The methodology used in this testing is described in detail in Bishop et al. 2013, Part 2, supra, and will not be repeated here for the sake of brevity.

Each of the parameter recoveries from the previous subsections were based on 2×10⁶ (innovation, ensemble-variance) pairs. We performed 60 completely independent parameter recoveries using 2×10⁶ synthetically generated (innovation, ensemble-variance) pairs. By computing the minimum, mean, maximum and standard-deviation of the recovered parameters and comparing these with the actual parameters that were used to generate the (innovation, ensemble-variance) pairs, we were able to robustly describe the accuracy of the parameter recoveries obtained from Equations (7)-(13).

We tested six distinct parameter sets, each precisely corresponding to the parameters retrieved from six distinct ETKF/Lorenz model runs that were identical to those performed as described above and in Appendix A to Bishop et al. 2013, Part 1, supra, except that the model error variance parameter q was set to differing values. The given M and model error parameter values corresponding to these sets are given by (q=0.0001, M=8), (q=0.001, M=8), (q=0.01, M=8), (q=0.0001, M=2), (q=0.001, M=2) and (q=0.01, M=2) cases.

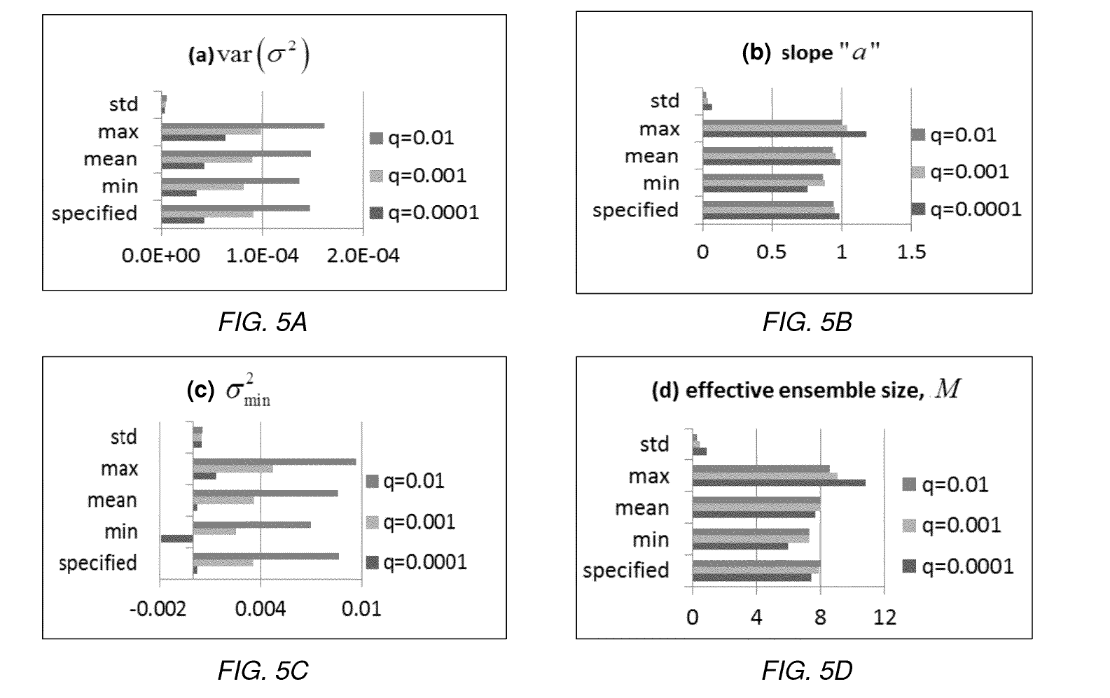

The plots shown in FIGS. 5A-5D give the parameter retrieval results from the (q=0.0001, M=8), (q=0.001, M=8) and (q=0.01, M=8) parameter sets, where retrieved parameters, var(σ²), a, σₘᵢₙ², and M are shown in FIGS. 5A, 5B, 5C, and 5D, respectively. Each plot summarizes information from 60 independent attempts to retrieve the parameters from 2,000,000 (innovation, ensemble-variance) pairs synthetically generated from specified distributions. The values marked “specified” are equal to values retrieved from Lorenz model experiments with a “given” M=8 and differing values of the model error q. Black, light-gray, and gray bars correspond to q values of 0.0001, 0.001, and 0.01, respectively. The values marked as min, mean, max and std are the minimum, mean, maximum and standard-deviation of the values retrieved from 60 completely independent synthetically generated data sets. Comparison of the specified values of var(σ²), σₘᵢₙ², a, and M with the mean of the 60 retrieved values shows that the mean value is very close to the specified value.

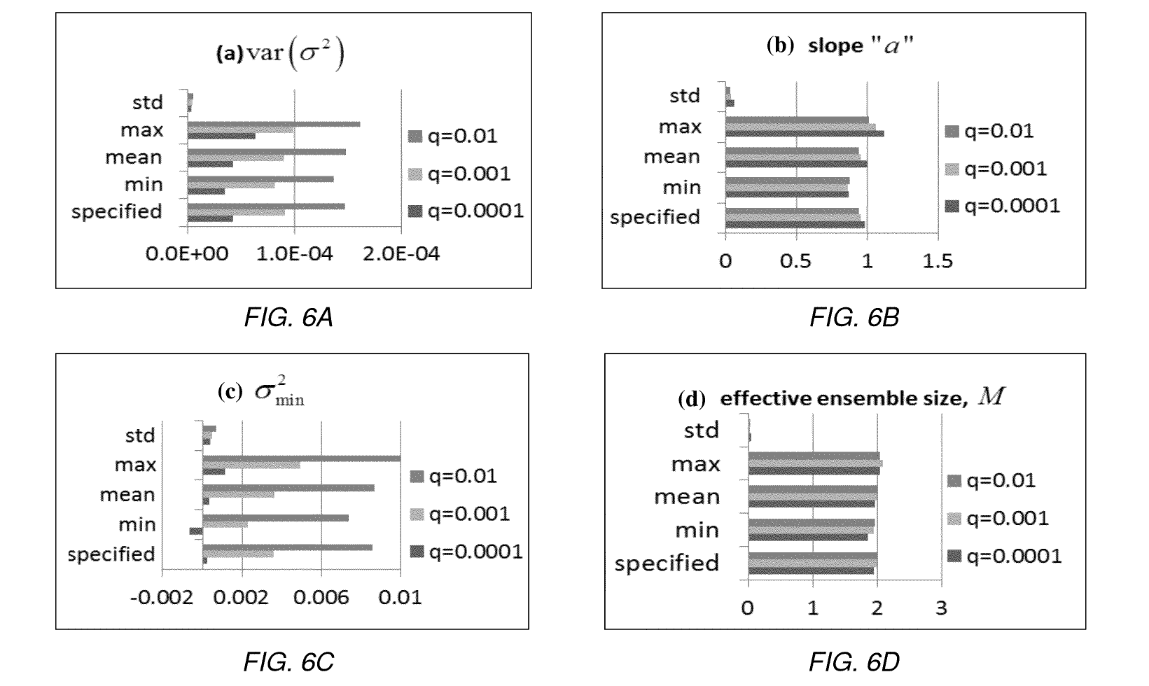

The plots in FIGS. 6A-6C give the corresponding retrievals for the (q=0.0001, M=2), (q=0.001, M=2) and (q=0.01, M=2) cases, where retrieved parameters, var(σ²), a, σₘᵢₙ², and M are shown in FIGS. 6A, 6B, 6C, and 6D, respectively. Because the retrieval of var(σ²) for these cases is the same as for the M=8 case, FIG. 6A is identical to FIG. 5A. In addition, a comparison of FIGS. 6B and 6C to FIGS. 5B and 5C shows that accuracy of the retrievals of the slope parameter a and of σₘᵢₙ² is similar for both the M=2 and M=8 cases. Moreover, a comparison of FIG. 6D with FIG. 5D shows that the recovery of effective ensemble size is reasonably accurate for both the M=2 case and M=8 case.

These results incontrovertibly demonstrate that Equations (7)-(13) recover the true parameters when the number of independent samples is large enough. Comparison of the specified values with the minimum, maximum and standard deviation of the retrieved values over the 60 trials shows that the retrievals from a single set of (innovation, ensemble-variance) pairs becomes more accurate as the model error parameter q increases. In addition, the accuracy of retrievals from single sets of 2×10⁶ (innovation, ensemble-variance) pairs using Equations (7)-(13) is usefully accurate for all hidden variables except for σₘᵢₙ² in the q=0.0001 case. In that case, a larger sample size than 2×10⁶ pairs would be required in order to make the noise in the recovered value small in comparison with the already very small σₘᵢₙ² value.

### Advantages and New Features

Our hidden variance instrument is the first of its kind. We know of no other instrument that can infer (i) the variance of a climatological, that is, a prior historical, distribution of conditioned variances (ii) the climatological minimum of conditioned variance (iii) the variance of variance predictions about the true conditioned variance, and (iv) the rate of change with the true conditioned variance of the mean of the distribution of predicted variances given a true conditioned variance. As mentioned previously, these measures allow the stochastic aspect of error variance prediction inaccuracy to be distinguished from the systematic part of error variance prediction inaccuracy. We know of no other instrument in existence that can make this distinction.

Anyone in possession of this instrument who wants to compare the variance prediction accuracy of two competing variance prediction schemes will have significant advantages over anyone who does not have this instrument.

Accurate variance prediction is particularly important in data assimilation systems which attempt to usefully blend information from short term forecasts with recent observations. Data assimilation systems are a fundamental component of any weather forecasting system. To optimize such state estimation systems one needs a single estimate of the instantaneous forecast error variance. It can be shown that when the flow dependent prediction of forecast error variance is imperfect then the optimal prediction of forecast error variance is a weighted average of a static, climatological estimate of forecast error variance and the flow dependent prediction of forecast error variance. With our measuring instrument, the optimal weights for variance prediction can be deduced from a single run of the data assimilation system. These optimal weights are those that give the mean of the inverse-gamma distribution of true error variances given an imperfect ensemble variance s². The relevant equations to obtain these optimal weights are given by Equations (22)-(25) discussion pertaining to them.

Hence, it is easy for someone in possession of our invention to obtain spatially varying optimal weights whereas it is virtually impossible for someone without access to our invention to obtain useful spatially varying weights.

### Alternatives

Alternative measuring tools closely associated with the variance parameters measuring tool described by Equations (7) to (13) are described in the following.

Estimator of Hidden Variance Distributions with σₘᵢₙ²=0 Assumption

In some systems, it may be known that the prior historical minimum of instantaneous variance is indistinguishable from zero. In such circumstances, Equations (7), (8), and (9) for [symbol] σ² [symbol] , sₘᵢₙ² and var(σ²) will remain unchanged (although, in this case, the designer of the instantaneous variance prediction systems may choose to ensure that sₘᵢₙ²=0 and then replace (7) by sₘᵢₙ²=0). In this case, equation (10) can be replaced by

$$a = \frac{〈 {s}^{2} 〉 - {s}_{min}^{2}}{〈 {σ}^{2} 〉} . \qquad ( 27 )$$

Hence, in this version of the estimator, the slope parameter a corresponds to a measure of the factor by which [symbol] s² [symbol] −sₘᵢₙ² exceeds [symbol] σ² [symbol] . Equation (11) is replaced by the assumption that σₘᵢₙ²=0 while the expression for k⁻¹ (equation 12) is unchanged.

### Alternative Estimator of Var(σ²) (Alternative to Equation (9))

The present invention also provides an alternative to the measuring tool for estimating var(σ²) of Equation (9), which is useful when the ratio of the prior historical variance of true variance divided by the square prior historical mean variance var(σ²)/( [symbol] σ² [symbol] −σₘᵢₙ²)² is very large and when the prior historical distribution of true error variances is precisely described by an inverse-gamma distribution. Equation (9) above gives var(σ²) in terms of the expected value of the 4^{th} power of the innovation [symbol] v⁴ [symbol] . However, the sample size required to accurately estimate [symbol] v⁴ [symbol] increases as the ratio var(σ²)/( [symbol] σ² [symbol] −σₘᵢₙ²)² increases, and so an alternative approach may be preferable in cases in which the ratio of the prior historical variance of true variance divided by the square prior historical mean variance var(σ²)/( [symbol] σ² [symbol] −σₘᵢₙ²)² is very large, the ratio of the minimum possible true variance divided by the mean variance σₘᵢₙ²/ [symbol] σ² [symbol] is small, and the prior historical distribution of instantaneous variances is well-approximated by the inverse-gamma distribution.

The operation of this alternative tool for measuring var(σ²), i.e., the variance of the prior historical distribution of instantaneous variances can be summarized as follows:
(i) Break the available set of Nₜ innovations into N_{g}=Nₜ/Nₛ sub-groups each containing Nₛ realization of innovations. For each of the subgroups j=1, 2, . . . , N_{g} compute

$${η}_{j} = \frac{1}{{N}_{s}} ( {\sum }_{i = 1}^{{N}_{s}} ( {v}_{ij}^{2} ) ) - R , \qquad ( 28 )$$

where vᵢⱼ=yᵢⱼ−xᵢⱼ^{f} is the ith innovation from the jth sub-group;

$$\begin{matrix}( ii ) Compute & \\ 〈 \frac{1}{η} 〉 \approx \frac{1}{{N}_{g}} {\sum }_{j = 1}^{{N}_{g}} \frac{1}{{η}_{j}} and 〈 η 〉 = ( 〈 {σ}^{2} 〉 + R ) - R = 〈 {σ}^{2} 〉 ; & ( 29 ) \\ ( iii ) Compute & \\ {β}_{η} = \frac{〈 η 〉}{( 〈 η 〉 〈 \frac{1}{η} 〉 - 1 )} and {α}_{η} = \frac{{β}_{η}}{〈 {σ}^{2} 〉} + 1 ; & ( 30 ) \\ ( iv ) Compute & \\ var ( η ) = \frac{{β}_{η}^{2}}{{( {α}_{η} - 1 )}^{2} ( {α}_{η} - 2 )} ; and & ( 31 ) \\ ( v ) Compute & \\ var ( {σ}^{2} ) = \frac{{N}_{s} var ( η ) - 2 {( 〈 {σ}^{2} 〉 + R )}^{2}}{3} . & ( 32 )\end{matrix}$$

### Algebraic Proof of Equations (30) and (32)

The proof is based on the assumption that

$${η}_{j} = \frac{1}{{N}_{s}} ( {\sum }_{i = 1}^{{N}_{s}} ( {v}_{ij}^{2} ) ) - R$$

has an inverse-Gamma distribution for some sufficiently large random sample size Nₛ. We also assume that the observation error variance R is the same for all observations. Let the parameters defining this inverse-gamma distribution of η be denoted α_{η} and β_{η}. Let the symbol ω=σ²+R denote the instantaneous innovation variance. It may be shown that

$$\begin{matrix}\begin{matrix}〈 \frac{1}{η} 〉 = \frac{{α}_{η}}{{β}_{η}} \\ \approx \frac{1}{{N}_{g}} {\sum }_{j = 1}^{{N}_{g}} \frac{1}{{η}_{j}}\end{matrix} \\ and \\ \begin{matrix}〈 η 〉 = ( 〈 {σ}^{2} 〉 + R ) - R \\ = 〈 {σ}^{2} 〉\end{matrix} & ( 33 a ) \\ ⇒ {α}_{η} = {β}_{η} 〈 \frac{1}{η} 〉 . & ( 33 b )\end{matrix}$$

The first part of equation (30) is justified by the fact that

$$\begin{matrix}{β}_{η} = 〈 {σ}^{2} 〉 ( α - 1 ) & ( 34 a ) \\ ⇒ - {β}_{η} = 〈 {σ}^{2} 〉 ( 1 - {β}_{η} 〈 \frac{1}{η} 〉 ) & ( 34 b ) \\ ⇒ - {β}_{η} + {β}_{η} 〈 \frac{1}{η} 〉 〈 {σ}^{2} 〉 = 〈 {σ}^{2} 〉 & ( 34 c ) \\ ⇒ {β}_{η} ( 〈 {σ}^{2} 〉 〈 \frac{1}{η} 〉 - 1 ) = 〈 {σ}^{2} 〉 & ( 34 d ) \\ \begin{matrix}⇒ {β}_{η} = \frac{〈 {σ}^{2} 〉}{( 〈 {σ}^{2} 〉 〈 \frac{1}{η} 〉 - 1 )} \\ = \frac{〈 η 〉}{( 〈 η 〉 〈 \frac{1}{η} 〉 - 1 )}\end{matrix} & ( 34 e )\end{matrix}$$

while the second part is obtained by rearranging the equation

$$〈 {σ}^{2} 〉 = \frac{{β}_{η}}{{α}_{η} - 1}$$

relating the mean of an inverse-gamma function to its parameters.

Equation (30) gives the parameters defining the inverse Gamma distribution approximation to the distribution of η.

Now to see how we can use this to estimate var(σ²). Note that since ω=σ²+R, it follows that var(σ²)=var(ω²)= [symbol] ω′² [symbol] where ω′=ω− [symbol] ω [symbol] =σ²− [symbol] σ² [symbol] . Also note that

$$\begin{matrix}〈 {η}^{2} 〉 = 〈 {( - R + \frac{1}{{N}_{s}} {\sum }_{i = 1}^{{N}_{s}} ( {v}_{i}^{2} ) )}^{2} 〉 \\ = 〈 ( {R}^{2} - 2 R \frac{1}{{N}_{s}} {\sum }_{i = 1}^{{N}_{s}} ( {v}_{i}^{2} ) + \frac{1}{{N}_{s}^{2}} {\sum }_{j = 1}^{{N}_{s}} {\sum }_{i = 1}^{{N}_{s}} ( {v}_{i}^{2} ) ( {v}_{j}^{2} ) ) 〉 \\ = {R}^{2} - 2 R 〈 ω 〉 + \frac{1}{{N}_{s}} {\sum }_{j = 1}^{{N}_{s}} {\sum }_{i = 1}^{{N}_{s}} 〈 [ {ζ}_{i}^{2} ( 〈 ω 〉 + {ω}_{i}^{′} ) ] [ {ζ}_{j}^{2} ( 〈 ω 〉 + {ω}_{j}^{′} ) ] 〉 \\ = {R}^{2} - 2 R 〈 ω 〉 + \frac{1}{{N}_{s}} {\sum }_{j = 1}^{{N}_{s}} {\sum }_{i = 1}^{{N}_{s}} 〈 \begin{matrix}[ [ {( {ζ}_{i}^{2} )}^{′} + 〈 {ζ}_{i}^{2} 〉 ] ( 〈 ω 〉 + {ω}_{i}^{′} ) ] \\ [ [ {( {ζ}_{j}^{2} )}^{′} + 〈 {ζ}_{j}^{2} 〉 ] ( 〈 ω 〉 + {ω}_{i}^{′} ) ]\end{matrix} 〉 \\ = {R}^{2} - 2 R 〈 ω 〉 + \frac{1}{{N}_{s}} {\sum }_{j = 1}^{{N}_{s}} {\sum }_{i = 1}^{{N}_{s}} 〈 \begin{matrix}[ [ {( {ζ}_{i}^{2} )}^{′} + 1 ] ( 〈 ω 〉 + {ω}_{i}^{′} ) ] \\ [ [ {( {ζ}_{i}^{2} )}^{′} + 1 ] ( 〈 ω 〉 + {ω}_{j}^{′} ) ]\end{matrix} 〉 \\ = {R}^{2} - 2 R 〈 ω 〉 + \frac{1}{{N}_{s}} {\sum }_{j = 1}^{{N}_{s}} {\sum }_{i = 1}^{{N}_{s}} 〈 \begin{matrix}\{ [ {( {ζ}_{i}^{2} )}^{′} ] ( 〈 ω 〉 + {ω}_{i}^{′} ) + ( 〈 ω 〉 + {ω}_{i}^{′} ) \} \times \\ \{ [ {( {ζ}_{j}^{2} )}^{′} ] ( 〈 ω 〉 + {ω}_{j}^{′} ) + ( 〈 ω 〉 + {ω}_{j}^{′} ) \}\end{matrix} 〉 \\ = {R}^{2} - 2 R 〈 ω 〉 + \frac{1}{{N}_{s}} {\sum }_{j = 1}^{{N}_{s}} {\sum }_{i = 1}^{{N}_{s}} 〈 \begin{matrix}\{ [ {( {ζ}_{i}^{2} )}^{′} ] [ {( {ζ}_{j}^{2} )}^{′} ] ( 〈 ω 〉 + {ω}_{i}^{′} ) ( 〈 ω 〉 + {ω}_{j}^{′} ) + \\ ( 〈 ω 〉 + {ω}_{i}^{′} ) ( 〈 ω 〉 + {ω}_{j}^{′} ) \} + \\ [ {( {ζ}_{i}^{2} )}^{′} ] ( 〈 ω 〉 + {ω}_{i}^{′} ) ( 〈 ω 〉 + {ω}_{j}^{′} ) + \\ [ {( {ζ}_{j}^{2} )}^{′} ] ( 〈 ω 〉 + {ω}_{j}^{′} ) + ( 〈 ω 〉 + {ω}_{i}^{′} )\end{matrix} 〉 \\ = {R}^{2} - 2 R 〈 ω 〉 + \frac{1}{{N}_{s}} {\sum }_{i = 1}^{{N}_{s}} 〈 {[ {( {ζ}_{i}^{2} )}^{′} ]}^{2} 〉 [ {〈 ω 〉}^{2} + 〈 {ω}^{{′}^{2}} 〉 ] + {N}_{s} {〈 ω 〉}^{2} + 〈 {ω}^{{′}^{2}} 〉 \\ = {R}^{2} - 2 R 〈 ω 〉 + {〈 ω 〉}^{2} + \frac{〈 {[ {( {ζ}_{i}^{2} )}^{′} ]}^{2} 〉 [ {〈 ω 〉}^{2} + var ( {σ}^{2} ) ] + var ( {σ}^{2} )}{{N}_{s}}\end{matrix}$$

Note also that for a normal distribution,

$$\begin{matrix}\begin{matrix}3 = 〈 {ζ}^{4} 〉 \\ = 〈 [ {( 〈 {ζ}^{2} 〉 + {( {ζ}_{i}^{2} )}^{′} )}^{2} ] 〉 \\ = 〈 {〈 {ζ}^{2} 〉}^{2} 〉 + 〈 {[ {( {ζ}_{i}^{2} )}^{′} ]}^{2} 〉 \\ = 1 + 〈 {[ {( {ζ}_{i}^{2} )}^{′} ]}^{2} 〉\end{matrix} & ( 36 a ) \\ ⇒ 〈 {[ {( {ζ}_{i}^{2} )}^{′} ]}^{2} 〉 = 2 & ( 36 b )\end{matrix}$$

Using Equations (35) and (36a/b), the variance of η is given by

$$\begin{matrix}var ( η ) = 〈 {η}^{2} 〉 - 〈 {η}^{2} 〉 \\ = 〈 {η}^{2} 〉 - ( 〈 ω 〉 - {R}^{2} ) \\ = \frac{〈 {[ {( {ζ}_{i}^{2} )}^{′} ]}^{2} 〉 [ {〈 ω 〉}^{2} + var ( {σ}^{2} ) ] + var ( {σ}^{2} )}{{N}_{s}} \\ = \frac{2 \{ [ {〈 ω 〉}^{2} + var ( {σ}^{2} ) ] \} + var ( {σ}^{2} )}{{N}_{s}} \\ = \frac{3 var ( {σ}^{2} )}{{N}_{s}} + \frac{2 \{ {〈 ω 〉}^{2} \}}{{N}_{s}}\end{matrix} \qquad ( 37 )$$

Using ω=σ²+R in Equation (37) and rearranging then yields equation (32).

Thus, as described above, the present invention provides computer-implemented methods for obtaining parameters of a prior historical distribution of error variances which are considered to be “hidden” because they cannot be readily determined. The present invention also provides methods for estimating the mean [symbol] s²|σ² [symbol] , minimum sₘᵢₙ², and relative variance k⁻¹ of the distribution ρ_{L}(s²|σ²) of variance predictions s² given a fixed true error variance σ², and gives the random or stochastic component of error variance prediction accuracy in terms of the relative variance k⁻¹. Finally, the present invention also provides methods for estimating the mean, minimum, and relative variance of the posterior distribution ρ_{P}(σ²|s²) of true variances given an imperfect error variance prediction s².

Although particular embodiments, aspects, and features have been described and illustrated, it should be noted that the invention described herein is not limited to only those embodiments, aspects, and features, and it should be readily appreciated that modifications may be made by persons skilled in the art. The present application contemplates any and all modifications within the spirit and scope of the underlying invention described and claimed herein, and all such embodiments are within the scope and spirit of the present disclosure.

What is claimed is:

1. A computer-implemented method for finding a variance var(σ²) of a prior historical distribution ρ_{C}(σ²) of hidden error variances associated with an input data set, the method being carried out by a computer programmed with instructions directing the computer to carry out the following steps:
receiving, at the computer, a set of (innovation, ensemble-variance) data pairs (vᵢ, sᵢ²), i=1, 2, . . . , n from a single ensemble forecasting system;
receiving, at the computer, data representing a true error variance Rᵢ for each ith observation;
computing, at the computer, [symbol] v⁴ [symbol] , a mean of a 4^{th} power of each innovation vᵢ;
computing, at the computer, [symbol] σ² [symbol] , a mean of a prior historical distribution of instantaneous variances, where [symbol] σ² [symbol] = [symbol] v²−R [symbol] ;
computing, at the computer, [symbol] R [symbol] , a mean of the true error variances Rᵢ;
computing, at the computer, var(R), a variance of the true error variances Rᵢ; and
computing, at the computer, var(σ²), where
$$\begin{matrix}var ( {σ}^{2} ) = \frac{〈 {v}^{4} 〉}{3} - {( 〈 {σ}^{2} 〉 + 〈 R 〉 )}^{2} - var ( R ) \\ = {( 〈 {σ}^{2} 〉 + 〈 R 〉 )}^{2} [ \frac{kurtosis ( v ) - 3}{3} ] - var ( R ) .\end{matrix}$$

2. A computer-implemented method for finding a parameter “a” defining a mean response of variance predictions to changes in an instantaneous variance, the method being carried out by a computer programmed with instructions directing the computer to carry out the following steps:
receiving, at the computer, a set of (innovation, ensemble-variance) data pairs (vᵢ, sᵢ²), i=1, 2, . . . , n from a single ensemble forecasting system;
receiving, at the computer, data of a variance var(σ²) of a prior historical distribution of instantaneous variances;
computing, at the computer, covar(v², s²), the covariance of v² and s²; and
computing, at the computer, a, where
$$a = \frac{covar ( {v}^{2} , {s}^{2} )}{var ( {σ}^{2} )} .$$

3. A computer-implemented method for finding the minimum possible true variance σₘᵢₙ² of a prior historical distribution of hidden variances, the method being carried out by a computer programmed with instructions directing the computer to carry out the following steps:
receiving, at the computer, a set of (innovation, ensemble-variance) data pairs (vᵢ, sᵢ²), i=1, 2, . . . , n from a single ensemble forecasting system;
receiving, at the computer, data representing a true observation error variance Rᵢ for each ith observation;
receiving, at the computer, data representing covar(v², s²), the covariance of v² and s²;
computing, at the computer, [symbol] σ² [symbol] , a mean of a prior historical distribution of instantaneous true error variances, where [symbol]
σ² [symbol] = [symbol] v²−R [symbol] ;
computing, at the computer, sₘᵢₙ², a prior historical minimum of variance predictions, where
sₘᵢₙ²=min(sᵢ²);
computing, at the computer, a parameter “a” that defines a mean response of variance predictions to changes in an instantaneous variance, where
$$a = \frac{covar ( {v}^{2} , {s}^{2} )}{var ( {σ}^{2} )} ;$$
computing, at the computer, [symbol] s² [symbol] , a mean of a plurality of predictions of a variance of a prior historical distribution; and
computing, at the computer, σₘᵢₙ², where
$${σ}_{min}^{2} = 〈 {σ}^{2} 〉 - \frac{〈 {s}^{2} 〉 - {s}_{min}^{2}}{a} .$$

4. A method for measuring k⁻¹, the relative variance of the variance prediction error; the method being carried out by a computer programmed with instructions directing the computer carry out the following steps:
receiving, at the computer, a set of (innovation, ensemble-variance) data pairs (vᵢ, sᵢ²), i=1, 2, . . . , n from a single ensemble forecasting system;
receiving, at the computer, data representing a true observation error variance Rᵢ for each ith observation;
receiving, at the computer, data representing covar(v², s²), the covariance of v² and s²;
computing, at the computer, var(s²), a variance of a prior historical distribution of predicted variances;
computing, at the computer, [symbol] σ² [symbol] , a mean of a prior historical distribution of instantaneous true error variances, where [symbol]
σ² [symbol] = [symbol] v²−R [symbol] ;
computing, at the computer, sₘᵢₙ², a prior historical minimum of variance predictions, where
sₘᵢₙ²=min(sᵢ²);
computing, at the computer, a parameter “a” that defines a mean response of variance predictions to changes in an instantaneous variance, where
$$a = \frac{covar ( {v}^{2} , {s}^{2} )}{var ( {σ}^{2} )} ;$$
and
computing, at the computer, k⁻¹, where
$${k}^{- 1} = \frac{var ( {s}^{2} ) - {a}^{2} var ( {σ}^{2} )}{{a}^{2} [ {( 〈 {σ}^{2} 〉 - {σ}_{min}^{2} )}^{2} + var ( {σ}^{2} ) ]} .$$

5. A method for finding an effective ensemble size M, the method being carried out by a computer programmed with instructions directing the computer carry out the following steps:
receiving, at the computer, a set of (innovation, ensemble-variance) data pairs (vᵢ, sᵢ²), i=1, 2, . . . , n from a single ensemble forecasting system;
receiving, at the computer, data representing a true observation error variance Rᵢ for each ith observation;
receiving, at the computer, data representing covar(v², s²), the covariance of v² and s²;
computing, at the computer, var(s²), a variance of a prior historical distribution of predicted variances;
computing, at the computer, [symbol] σ² [symbol] , a mean of a prior historical distribution of instantaneous true error variances, where [symbol]
σ² [symbol] = [symbol] v²−R [symbol] ;
computing, at the computer, sₘᵢₙ², a prior historical minimum of variance predictions, where
sₘᵢₙ²=min(sᵢ²);
computing, at the computer, a parameter “a” that defines a mean response of variance predictions to changes in an instantaneous variance, where
$$a = \frac{covar ( {v}^{2} , {s}^{2} )}{var ( {σ}^{2} )} ;$$
computing, at the computer, k⁻¹, where
$${k}^{- 1} = \frac{var ( {s}^{2} ) - {a}^{2} var ( {σ}^{2} )}{{a}^{2} [ {( 〈 {σ}^{2} 〉 - {σ}_{min}^{2} )}^{2} + var ( {σ}^{2} ) ]} ;$$
and
computing, at the computer, the effective ensemble size M, where
M=2k+1.
